(19) United States
(12) Patent Application Publication
(10) Pub. No.: US 2007/0157205 A1
(43) Pub. Date: Jul. 5, 2007

(54) Method and system for reviewing tasks assigned to a user

(75) Inventor: Gaurav Wadhwa, Haryana (IN)

Correspondence Address: KENYON & KENYON LLP, RIVERPARK TOWERS, SUITE 600, 333 W. SAN CARLOS ST., SAN JOSE, CA, 95110, US

(73) Assignee: SAP AG

(21) Appl. No.: 11/319,428

(22) Filed: Dec. 29, 2005

(51) Int. Cl. G06F 9/46

(52) U.S. Cl. 718/102

(57) ABSTRACT

In a method and system for reviewing tasks assigned to a user, upon a user command, a computer system identifies records of sets assigned to the user. The computer system traverses at least one link in each set record that identifies at least one task record assigned to the respective set. Status information is then retrieved from one or more task records identified by the one or more links in each set record. The status information of the tasks assigned to a set is then displayed.

### BACKGROUND

Modern businesses often develop project-based approaches to their efforts. A project usually is organized as a complex series of tasks or assignments, which are performed by the business' employees, vendors and business partners. As a rudimentary example, a manufacturing process may include the gathering of raw materials, conversion of the raw materials into usable parts, and assembly and finishing of the parts into a final product. Often, these multiple tasks or assignments may be assigned to different employees, or a single employee may be responsible for overseeing more than one task. The businesses may use computers to manage such efforts.

While tasks may require performance of a physical or tangible act, they may also be embodied in the form of data in a computer system. Further, when each task is created and entered into a computer system, it may exist as an individual task. An individual task is an independent unit—it does not refer to other tasks that may have been established for a project and it does not show any interrelationships between the task and other tasks that may have been assigned. Thus, for an individual responsible for supervising multiple tasks, monitoring each task individually may prove to be time-consuming and inefficient.

Project tasks embodied in a computer data format may be stored in a database located in a computer system. The database may contain multiple tables, with each table holding records and fields. A record may consist of multiple pieces of unrelated data located within a row in a database, whereas each piece of unrelated data in the record may belong to a different column or field. To create records and tables to store data and access data stored in tables, a database query language, such as Structured Query Language (SQL) may be used. A database query language may thus be used to create a table or a record that represents an individual task. However, because data for each individual task may be stored in individual tables, a database user may have to run multiple database queries to retrieve needed information. Requiring multiple database queries to check the status of project tasks may become quite burdensome and inefficient for an employee responsible for overseeing multiple tasks.

Instead, what is needed is a method for grouping together tasks stored in multiple tables in a database to simplify the tracking of multiple tasks.

### BRIEF DESCRIPTION OF THE DRAWINGS

The invention is described in detail with reference to the following drawings wherein like numerals reference like elements, and wherein:

FIG. 1 illustrates a flowchart of one process for reviewing tasks assigned to a set.

FIG. 2 illustrates a flowchart of one process for assigning a set to one or more users.

FIG. 3 illustrates a flowchart of one process for retrieving the status information of a task or a set.

FIG. 4 illustrates a diagram of one embodiment for assigning tasks and sets.

FIG. 5 illustrates a diagram of one embodiment for retrieving the status information of a task or tasks assigned to a set.

### DETAILED DESCRIPTION

Embodiments of the present invention provide a method and system for reviewing tasks assigned to a user. The method identifies records of sets assigned to the user upon a user command. The computer system then traverses at least one link in each set record that identifies at least one task record assigned to the respective set. Status information for the one or more task records identified from the one or more links in each set record is then retrieved. The retrieved status information of the tasks assigned to the set is then displayed.

A project may be organized as a complex series of tasks or assignments. These tasks or assignments may be performed by multiple users or multiple tasks or assignments may be performed by a single user. Further, the tasks or assignments may be stored in a computer system individually. To more efficiently track multiple individual tasks, the user may create a set to group together assigned tasks. Grouping together assigned tasks in a set centralizes the tracking of the tasks. A user may track all tasks assigned to a set in one action rather than performing multiple actions to track multiple tasks. When a user creates a set, however, nothing is physically created or modified inside a computer system. Tasks may still exist and be stored individually in the computer system. Instead, a set may be viewed more as a construct or label attached to each task assigned to the set so as to permit an aggregation of tasks. In particular, in the present invention, a set may be viewed as a record in a database table. One field in the set embodied as a record may be a unique set identifier that serves as a key. A key permits a database query language, such as Structured Query Language (SQL), to locate data in multiple database tables as long as each database table contains the key. Thus, by associating each task assigned to a set with the set's unique set identifier, the set labels or associates the task with the set and permits more efficient retrieval of task data.

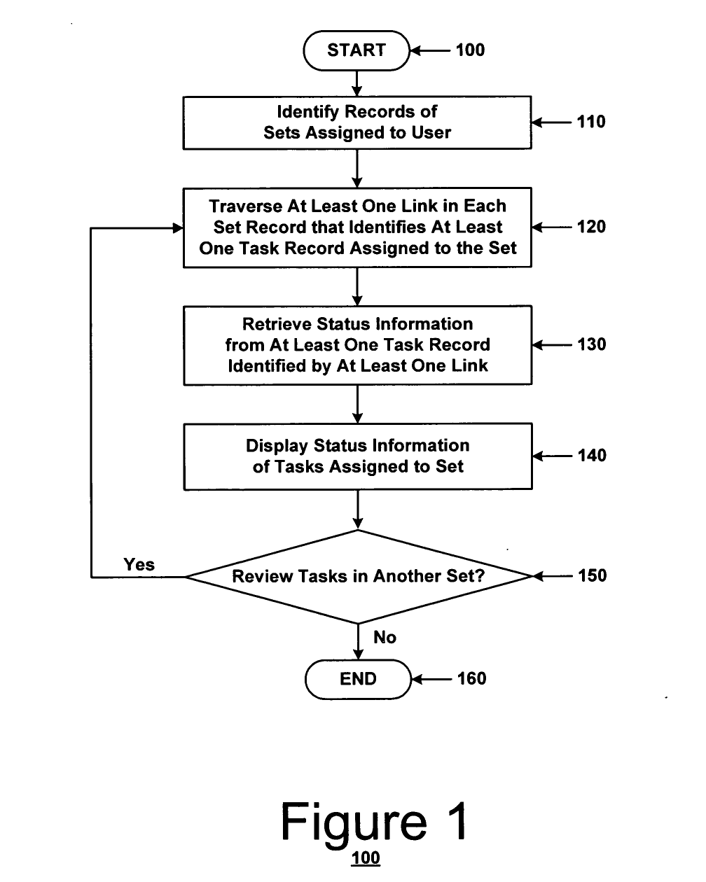

FIG. 1 illustrates in a flowchart an embodiment of a process for reviewing tasks assigned to a set. The process of grouping tasks begins with block 100, and in block 110, a computer system may, upon receiving a user command, identify records of sets assigned to the user. In block 120, following identification of sets assigned to the user, the computer system may traverse at least one link in each set record that identifies at least one task record assigned to the respective set. Each link that identifies a task record assigned to a set may be a unique task identifier. The unique task identifier and the unique set identifier may both be stored in one or more mapping tables. By traversing these mapping tables, the computer system may retrieve status information from each of the one or more task records identified by the one or more links in each set record, as shown in block 130. In block 140, the retrieved status information from one or more tasks assigned to the set may be displayed to the user. In one embodiment, the retrieved status information for tasks in different sets may be displayed in a manner as to differentiate between the sets. This displayed differentiation may involve using different windows to display each set or different headings to identify when retrieved status information for a set begins and ends. If a user wishes to review tasks in a different set, the user may, in block 150, repeat the traversing, retrieving, and displaying actions using a different set record. If the user does not wish to review tasks in a different set, the process ends in block 160.

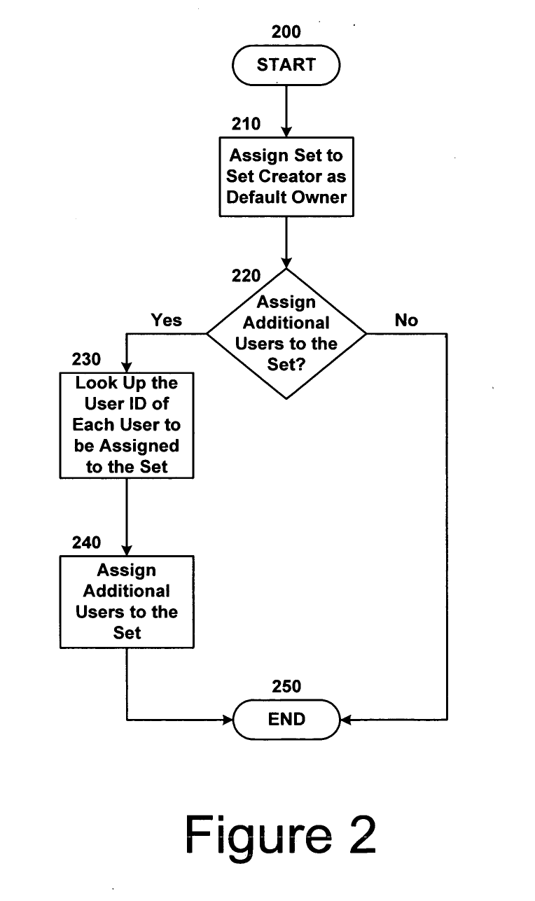

FIG. 2 illustrates in an embodiment a process for assigning users access rights to a set. The process begins in block 200. In block 210, during the creation of a set by the user, the device or computer system containing the database may assign access rights to the set by default to the user. In one embodiment, only users with access rights to a particular set may be allowed to view or modify the contents of the set. In block 220, the user may be presented with the option to authorize other users to access the set. If the user chooses to add additional users to the set, he may proceed to block 230 where he may look up or search for the username of each additional user to be added to the set. Every user in the computer system may possess a unique username which is stored in a user list. The user list itself may be stored in a table with each user's personal information. The user thus may query the database, using a query command such as the SQL commands SELECT and WHERE, to search the user list and return any desired usernames. Once the user has retrieved the necessary usernames, he may proceed to block 240. In block 240, the user may authorize the additional users to access the user's set. Authorization may be accomplished by inserting the additional user's username into the set record for the corresponding set. Insertion of usernames may be accomplished using a database query command, such as the SQL command INSERT INTO. SQL or other database query languages permit insertion of multiple records into a table, so a user may be able to assign multiple additional users in one step without the need for repetitious commands. Alternatively, the user may insert additional users into the record in the set table one at a time. If the user does not assign any additional users to the set, or once the user has finished assigning additional users to the set, the process ends at block 250.

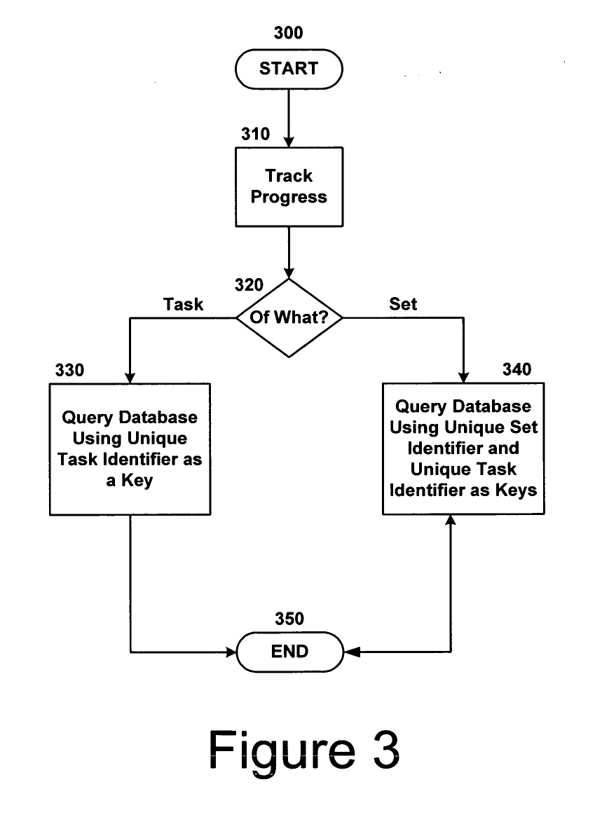

FIG. 3 illustrates in a flowchart an embodiment for reviewing tasks in a set or an individual task in more detail. The process begins in block 300. In block 310, the user may opt to track the progress of some or all of the tasks for which he is responsible. In block 320, the user may choose whether to review the progress of a task or a set. If the user desires to track the progress of a task assigned to the set, then in block 330, the user may issue a user command to the computer system that addresses a particular task. The computer system may then traverse links, such as unique task identifiers, in a particular set record, and execute a database query in response to the user command. The database query may use one of the links found in the set record that identifies the particular task. The task identifier may be used to map the set record containing the link or task identifier to a separate task table also containing the task identifier or link as well as status information about the task. In one embodiment, the user may also select a particular attribute of the task upon which to review the task. The task and information characterizing the task may be contained in one table. Information characterizing the task may include, among other things, the percentage of work completed, the percentage of work remaining, the amount of money spent on the task, and the amount of money remaining in the budget for the task. The database query thus may also include a parameter to search for the desired particular attribute of the task. The information for the particular task may then be retrieved for the user.

If the user decides to review the tasks assigned to the set, then in block 340, the user may select the set whose progress is to be tracked. Selection of the set may occur along similar lines to the method shown in FIG. 1. The computer system may, upon a different user command, identify records of sets contained in one or more mapping tables that are assigned to the user. To help identify which set records are assigned to the user, a set record may contain a field identifying user ownership of the set. Thus, in response to the user command, a computer system may search a set record for a particular username and return only those sets belonging to a particular user's username. In one embodiment, each user on a computer system may possess a unique username. Upon identification of sets belonging to a particular user, the computer system may begin retrieval of status information of tasks assigned to the set. The computer system may execute a database query to traverse one or more mapping tables using both the unique set identifier and unique task identifiers. In one embodiment, each task assigned to the set may be contained in a separate record in the mapping table. Each mapping table record may contain two keys, in the form of a unique set identifier and a unique task identifier. The unique set identifier may be used to identify all the tasks assigned to the set, and in turn, each unique task identifier for each task assigned to the set may be used to retrieve information on the task from each task's table. The database query executed by a computer system thus may involve traversing more than one mapping table to identify sets assigned to a particular user and to retrieve status information for the tasks assigned to those sets.

The status or progress of a set may likewise be measured by a certain characteristic of the tasks assigned to the set. Thus, in querying the database to retrieve the status of every task assigned to the set, the user may specify in the database query command that a certain characteristic common to all the tasks assigned to the set be retrieved. Once the user has tracked either the progress of an individual task assigned to a set or all the tasks assigned to the set, the process ends in step 350.

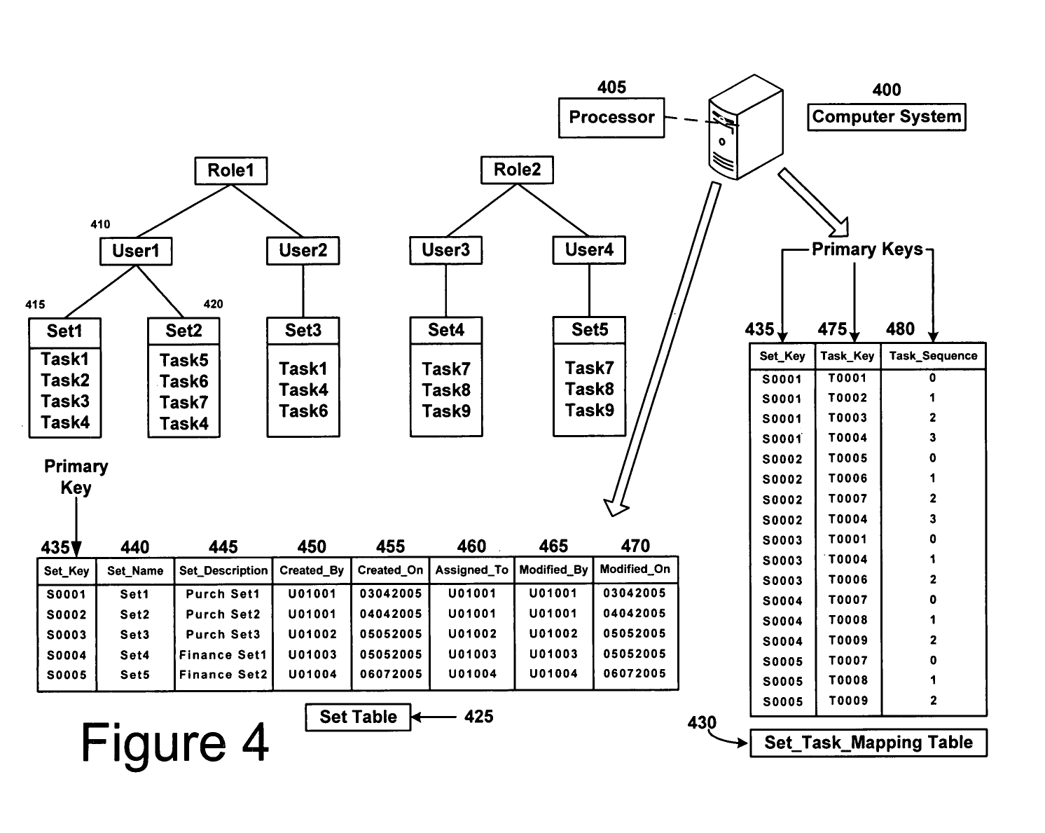

FIG. 4 illustrates in a diagram an embodiment for grouping tasks into sets. A user, denoted User1 410, may be assigned to oversee several parts of a project. The user may create the sets labeled Set1 415 and Set2 420 to organize the tasks the user is responsible for overseeing. Prior to the user creating the sets Set1 415 and Set2 420, a processor 405 in a computer system 400 may create a mapping table called Set Table 425 for storing information about the sets. Each set created by the user may be embodied as a record, or row, in the Set Table 425. The Set Table 425 may contain multiple characteristics of each created set and may store information for each set attribute as a separate field, or column, in the Set Table 425. A first set attribute that may be created is a Set_Key 435. The Set_Key 435 may be a unique set identifier that serves as the primary key for each set, meaning that knowledge of the Set_Key may enable a user to search for and find a particular set or to assign tasks to the set. In one embodiment, the Set_Key 435 is assigned to a set when the set is first created. Furthermore, the Set_Key 435 may be generated as a sequence, such as S0001, S0002, S0003, etc., or it may be user-defined. Another attribute of a set is a Set_Name 440. In one possible embodiment, the user may choose the Set_Name 440 on his or her own. Alternatively, the user may allow for the system or device to generate the Set_Name 440 as a sequence, such as Set1, Set2, Set3, etc.

As part of the Set Table 425, the user may enter a Set_Description 445 to describe the functionality or purpose of the set. Also, when the set is created, the computer system 400 may insert the username of the user who created the set into a Created_By field 450 of the Set Table 425. Likewise, the processor 405 in the system 400 may insert the set creation date in a Created_On field 455 using the system clock of the system 400. Each set may then be assigned to a user or multiple users. The user or users assigned to the set may be documented in an Assigned_To field 460. In one embodiment, the processor 405 in the computer system 400 will by default assign the set to the user who creates the set. Alternatively, the creator of the set may also assign other users access rights to the set by inserting their respective usernames in the Assigned_To field 460. The processor 405 in the computer system 400 may also track the most recent user to modify the set in the form of a Modified_By field 465 in the Set Table 425. The Modified_By field 465 may contain the username of the most recent user to modify the set. Finally, the processor 405 in the computer system 400 may document the date the most recent modification took place. The date may be determined by noting the date of the system clock of the computer system or device 400 when the contents of the set are saved or modified and may be saved in a Modified_On field 470.

Each set may contain some combination of tasks selected from a task list already existing within the device or system. Each set may also have identical tasks that are arranged in different order. For instance, in one possible embodiment, Set1 415 may contain four tasks, Task1 through Task4, while Set2 420 may contain Task5, Task6, Task7, and Task4. Prior to when the user creates a set and assigns tasks to the set, a second mapping table may be created to map the set and the assigned tasks. In one embodiment, this second mapping table may be a Set_Task_Mapping Table 430 created by the user. The Set_Task_Mapping Table 430 may contain three columns: a Set_Key 435 identical to that found in the Set Table 425, a Task_Key 475, and a Task_Sequence 480 respectively. The Task_Key 475 may be a unique identifier for each task. Similar to the creation of the Set_Key 435, the Task_Key 475 may be generated sequentially, or alternatively, may be defined by the user. The Set_Task_Mapping Table 430 may operate by linking and assigning each task to its assigned set through the use of Set_Keys 435 and Task_Keys 475. A Task_Sequence 480 may also be associated with each Task_Key 475 for a particular Set_Key 435 to identify the order the task is to be performed within the set. A record in the Set_Task_Mapping Table 430 is thus formed by inserting a Set_Key 435, a corresponding Task_Key 475, and a Task_Sequence 480 in a row. A set may be embodied in the Set_Task_Mapping Table 430 by a single record or multiple records, depending on the number of tasks assigned to a set.

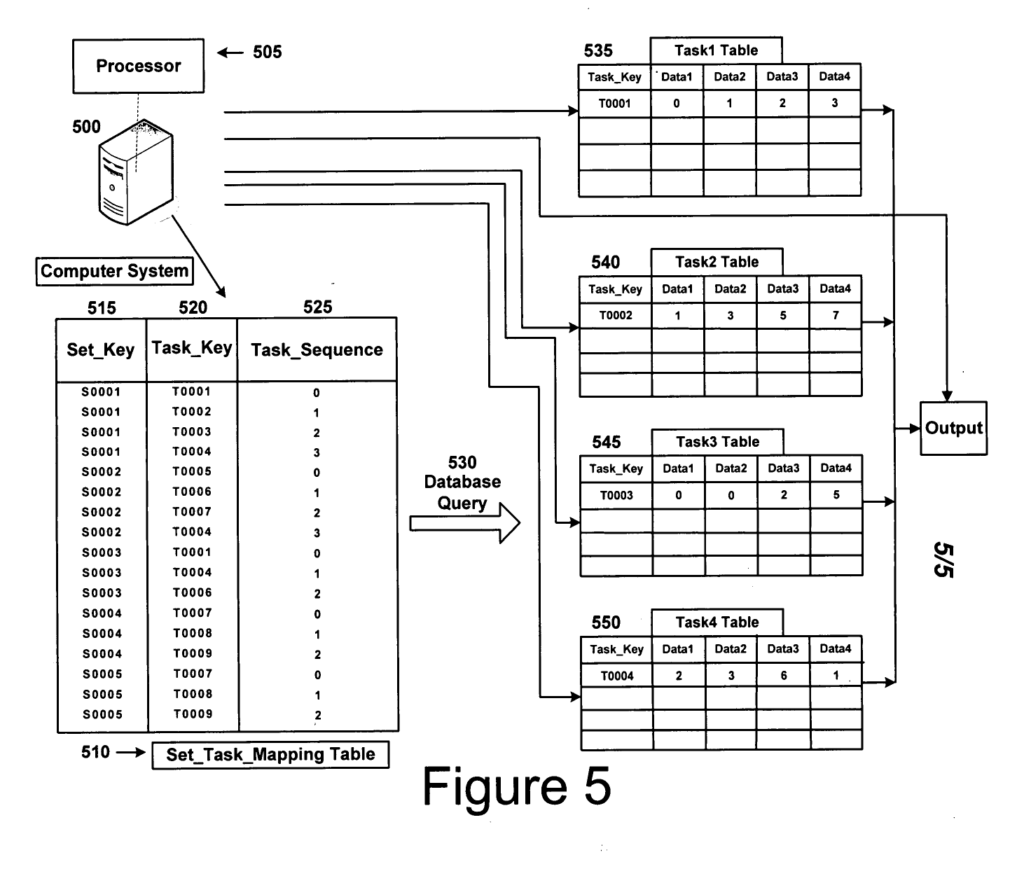

FIG. 5 illustrates in a diagram one embodiment for retrieving the status of a task or a set. A computer system 500 holds the Set_Task_Mapping Table 510, as well as task tables for tasks T0001 535, T0002 540, T0003 545, and T0004 550. Each task may be embodied by one of the task tables and may exist in the system 500. A user seeking to retrieve the status information of a particular task in a set may enter a user command telling the computer system to retrieve information for a task containing a particular Task_Key 520. In one embodiment, the processor 505 in the computer system 500 may then execute a database query 530, such as a SQL SELECT command, in response to the selected Task_Key 520. As a result, the query 530 may search for the particular Task_Key 520 within all the tables residing in the database of the computer system 500. Information contained in any table possessing the same Task_Key 520 may then be retrieved for the user to review.

In one embodiment, a status information of a set may be retrieved. Because the Mapping Table 510 uses a Set_Key 515 and Task_Keys 520 as primary keys, a computer system 500 may use those primary keys to search for task characteristics contained in individual task tables, such as the tables for Task1 535, Task2 540, Task3 545, and Task4 550, that also contain either or both a Set_Key 515 or a Task_Key 520. More specifically, a user may enter a different user command telling the computer system to search for a particular set assigned to the user. The processor 505 in the computer system 500 may then traverse the Set_Table 425 as shown in FIG. 4 and link a Set_Key 435 in the Set Table 425 with an identical Set_Key 435 found in the Set_Task_Mapping Table 430. The Set_Keys and Set_Task_Mapping Table as found in FIG. 4 are identical to those illustrated in FIG. 5. Each Task_Key 520 found in a Set_Task_Mapping Table record containing the Set_Key 515 may then be used to link the Task_Key 520 in the Mapping Table 510 with the Task_Key 520 found in a task table. In one embodiment, a database query, such as a combination of the SQL SELECT and WHERE commands, may be used with the Task_Key 520 and Set_Key 515 as query parameters to retrieve task characteristics for the tasks assigned to the set. Additionally, the user may specify that a certain task characteristic or characteristics common to all the tasks assigned to the set be retrieved. This task characteristic may be added to the database query as a query parameter. Once a task table with the Task_Key 520 has been found by the database query, the query should retrieve the requested task characteristic for the user to review.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

What is claimed is:

1. In a computer system, a method of reviewing tasks assigned to a user, comprising:
upon a first command, identifying records of sets assigned to the user,
traversing at least one link in at least one set record that identifies at least one task record assigned to the respective set, and
for at least one set,
retrieving status information from the at least one task record identified by the at least one link, and
displaying the status information of the tasks in correspondence to the set.

2. The method of claim 1, further comprising, upon a second user command that addresses a task record, retrieving and displaying status information from the addressed task record.

3. The method of claim 1, wherein the at least one link is stored in at least one mapping table, each of the at least one mapping table associated with the sets assigned to the user.

4. The method of claim 1, wherein the status information for each set is displayed in a manner that differentiates the sets from each other.

5. The method of claim 3, wherein each set record assigned to the user is identified by a unique set identifier.

6. The method of claim 5, wherein the at least one link that identifies at least one task record is a unique task identifier.

7. The method of claim 6, wherein each of the at least one task record assigned to the set is assigned a unique task sequence number.

8. The method of claim 6, wherein the at least one task record is assigned to the set by inserting in the unique task identifier into a set record containing the corresponding unique set identifier in the at least one mapping table.

9. The method of claim 1, further comprising, upon a second user command, authorizing guests to access the records of sets assigned to the user.

10. A computer system, comprising:
an interface to upon command, identify records of sets assigned to the user;
a processor to traverse at least one link in at least one set record that identifies at least one task record assigned to the respective set; and for at least one set, retrieve status information from the at least one task record identified by the at least one link; and
a display unit to display the retrieve status information of the tasks in correspondence to the set.

11. The computer system of claim 10, wherein
the interface is further configured to receive a second user command addressing a task record;
the processor is further configured to retrieve status information from the addressed task record; and
the display unit is further configured to display the retrieved status information from the addressed task record.

12. The computer system of claim 10, wherein the at least one link is stored in at least one mapping table, each of the at least one mapping table associated with the sets assigned to the user.

13. The computer system of claim 10, wherein the retrieved status information for each set is displayed in a manner that differentiates the sets from each other.

14. The computer system of claim 12, wherein each set record assigned to the user is identified by a unique set identifier.

15. The computer system of claim 14, wherein the at least one link that identifies at least one task record is a unique task identifier.

16. The computer system of claim 15, wherein each of the at least one task record assigned to the set is assigned a unique task sequence number.

17. The computer system of claim 15, wherein the at least one task record is assigned to the set by inserting the unique task identifier into a set record containing the corresponding unique set identifier in the at least one mapping table.

18. The computer system of claim 10, wherein:
the interface is further configured to receive a second user command, and
the processor is further configured to authorize a guest to access the records of sets assigned to the user upon receipt of the second user command by the interface.

19. A computer-readable storage medium storing a set of instructions, the set of instructions capable of causing a computer to implement a method comprising:
upon command, identifying records of sets assigned to a user;
traversing at least one link in at least one set record that identifies at least one task record assigned to the respective set; and
for at least one set, retrieving status information from the at least one task record identified by the at least one link, and displaying the retrieve status information of the tasks in correspondence to the set.

20. The computer-readable storage medium of claim 19, further comprising, upon a second user command that addresses a task record, retrieving and displaying status information from the addressed task record.

21. The computer-readable storage medium of claim 19, wherein the at least one link is stored in at least one mapping table, each of the at least one mapping table associated with the sets assigned to the user.

22. The computer-readable storage medium of claim 19, wherein the retrieved status information for each set is displayed in a manner that differentiates the sets from each other.

23. The computer-readable storage medium of claim 21, wherein each set record assigned to the user is identified by a unique set identifier.

24. The computer-readable storage medium of claim 23, wherein the at least one link that identifies at least one task record is a unique task identifier.

25. The computer-readable storage medium of claim 24, wherein each of the at least one task record assigned to the set is assigned a unique task sequence number.

26. The computer-readable storage medium of claim 24, wherein the at least one task record is assigned to the set by inserting the unique task identifier into a set record containing the corresponding unique set identifier in the at least one mapping table.

27. The computer-readable storage medium of claim 19, further comprising, upon a second user command, authorizing guests to access the records of sets assigned to the user.
